(19) United States
(12) Patent Application Publication
(10) Pub. No.: US 2024/0368373 A1
(43) Pub. Date: Nov. 7, 2024

(54) PLASTICIZED POLYVINYL CHLORIDE COMPOSITIONS WITH ENHANCED RESISTANCE TO BIOLOGICAL GROWTH

(71) Applicant: OXY USA INC., Houston, TX (US)

(72) Inventors: Robert L. ZELLER, III, Seabrook, TX (US); Robert E. DETTERMAN, Medina, OH (US); Jennifer HOSTETLER, Sheffield Lake, OH (US)

(21) Appl. No.: 18/776,891

(22) Filed: Jul. 18, 2024

Related U.S. Application Data
(63) Continuation of application No. 17/297,437, filed on May 26, 2021.
(60) Provisional application No. 62/772,201, filed on Nov. 28, 2018.

(51) Int. Cl. C08K 3/06; C08K 3/013; C08K 5/00; C08K 5/12

(52) U.S. Cl. CPC C08K 3/06; C08K 3/013; C08K 5/005; C08K 5/12

(57) ABSTRACT

A PVC composition comprising polyvinyl chloride, a plasticizer, and sulfur, where the PVC composition includes from about 0.05 part to 5.0 parts by weight sulfur per 100 parts by weight of the PVC in the PVC composition.

This application is a continuation application of U.S. application Ser. No. 17/297,437 filed on May 26, 2021, which is a national-stage application of PCT/US2019/063422 filed on Nov. 26, 2019, and claims the benefit of U.S. provisional application No. 62/772,201 filed on Nov. 28, 2018, which are incorporated herein by reference.

### FIELD OF THE INVENTION

Embodiments of this invention relate to plasticized polyvinyl chloride compositions that include sulfur. The plasticized polyvinyl chloride compositions have enhanced resistance to biological growth such as fungal growth.

### BACKGROUND OF THE INVENTION

Polyvinyl chloride, which may also be referred to as PVC, is widely used in several industries due to its durability, corrosion resistance, flame resistance, low cost, and high strength. For example, PVC is widely used in applications such as pipes and pipe fittings, films, sheets, flooring, cables, and construction articles.

PVC is typically rigid at ambient temperatures. The rigidity of PVC is due to strong intermolecular forces that hold the polymer chains close together. Plasticizers are added to soften PVC compositions and thereby form semi-rigid or flexible materials, which are often referred to as plasticized PVC compositions. It is believed that the plasticizer molecules soften the PVC compositions by inserting themselves between the PVC chains to prevent the chains from participating in intermolecular forces. The addition of a plasticizer may improve one or more properties of a PVC composition such as processability, flexibility, durability, stretchability, melt viscosity, glass transition temperature, and modulus of elasticity.

While plasticized PVC compositions are useful, often the presence of the plasticizers, either alone or in combination with other additives, results in a composition that is susceptible to fungal growth.

Sulfur has been added to plasticized PVC compositions. For example, U.S. Pat. No. 3,251,797 teaches the addition of sulfur and the reaction products of sulfur and ethylenically unsaturated organic compounds in place of plasticizers. The sulfur is present in these compositions in an amount from about 5 to about 25 parts by weight sulfur per 100 parts by weight vinyl chloride polymer. It is also known to add sulfur to plasticized PVC compositions to increase thermal and thermo-oxidative stability. Namely, as disclosed by Akhmethhanov, et al., in Using the Element Sulfur as a Stabilizer for Polymers of Vinyl Chloride, the introduction of sulfur in amounts up to 0.05 parts by weight per 100 parts by weight PVC increases the heat stability of plasticized PVC compositions.

### SUMMARY OF THE INVENTION

One or more embodiments of the present invention provide a PVC composition comprising (i) polyvinyl chloride, (ii) a plasticizer, and (iii) sulfur, where the PVC composition includes from about 0.05 part to 5.0 parts by weight sulfur per 100 parts by weight of the PVC in the PVC composition.

Yet other embodiments of the present invention provide an article prepared from a PVC composition comprising (i) polyvinyl chloride, (ii) a plasticizer, and (iii) sulfur, where the PVC composition includes from about 0.05 part to 5.0 parts by weight sulfur per 100 parts by weight of the PVC in the PVC composition.

Still other embodiments of the present invention provide a method for preparing a PVC composition having improved resistance to biological growth; the method comprising mixing (i) polyvinyl chloride, (ii) a plasticizer, and (iii) sulfur, to form a PVC composition where the PVC composition includes from about 0.05 part to 5.0 parts by weight sulfur per 100 parts by weight of the PVC in the PVC composition.

### DETAILED DESCRIPTION OF ILLUSTRATIVE EMBODIMENTS

Embodiments of the invention are based, at least in part, on the discovery of plasticized PVC compositions that include tailored amounts of sulfur. It has been unexpectedly discovered that sulfur, when loaded at threshold amounts, provides plasticized PVC compositions with resistance to biological growth such as fungal growth. Moreover, when maintained below certain loadings, the sulfur has little to no appreciable impact on the technological usefulness of the plasticized PVC compositions. Accordingly, embodiments of the present invention are directed toward plasticized PVC compositions that include PVC, plasticizer, and sulfur.

### Sulfur

Suitable types of sulfur for use in the PVC composition include elemental sulfur (free sulfur). Exemplary allotropes of sulfur include polymeric sulfur and S8.

In one or more embodiments, the amount of sulfur within the PVC composition may be described in “parts by weight of the sulfur per 100 parts by weight PVC,” which the skilled person understands can be represented by the notation “phr.” In one or more embodiments, the plasticized PVC compositions of the present invention include greater than 0.05, in other embodiments greater than 0.10, in other embodiments greater than 0.12, in other embodiments greater than 0.15, in other embodiments greater than 0.20, in other embodiments greater than 0.30, in other embodiments greater than 0.50, in other embodiments greater than 0.60, in other embodiments greater than 0.75, and in other embodiments greater than 1.0 sulfur phr (i.e. parts by weight sulfur per 100 parts by weight PVC). In these or other embodiments, the plasticized PVC compositions of the present invention include less than 5.0, in other embodiments less than 3.0, in other embodiments less than 2.5, in other embodiments less than 2.2, in other embodiments less than 2.0, in other embodiments less than 1.7, in other embodiments less than 1.5, in other embodiments less than 1.3, and in other embodiments less than 1.0 phr. In one or more embodiments, the plasticized PVC compositions of the present invention include from about 0.05 to about 5.0 phr, in other embodiments about 0.10 to about 3.0 phr, in other embodiments about 0.12 to about 2.5 phr, in other embodiments about 0.15 to about 2.2 phr, in other embodiments about 0.20 to about 2.0 phr, in other embodiments about 0.25 to about 0.75 phr, in other embodiments about 0.30 to about 0.60 phr, in other embodiments from about 0.50 to about 1.5 phr, in other embodiments from about 0.60 to about 1.3 phr, and in other embodiments about 0.75 to 1.0 phr.

### Polyvinyl Chloride

In one or more embodiments, the polyvinyl chloride (PVC) that is useful in practicing the present invention may include conventional forms of PVC. Suitable PVC may be obtained via polymerization of vinyl chloride in bulk, suspension, emulsion, micro suspension, and suspended emulsion polymerizations. In one or more embodiments, the PVC may be a homopolymer of vinyl chloride or copolymer of vinyl chloride and one or more additional co-monomers. In one or more embodiments, where vinyl chloride is polymerized with a co-monomer to prepare a copolymer, the copolymer may substantially include units or residues of vinyl chloride. In one or more embodiments, the copolymer may include from about 1% to about 30%, in other embodiments from about 5% to about 20%, and in other embodiments from about 10% to about 15% of a comonomer residues by weight with the balance being vinyl chloride. Exemplary comonomers for polymerization with vinyl chloride include vinylidene chloride, vinyl acetate, methylacrylate, methyl methacrylate, acrylonitrile, vinyl ether, vinyl fluoride, or vinylidene fluoride. Since both polyvinyl chloride homopolymer and vinyl chloride copolymers are useful, both will be encompassed by the term PVC unless otherwise stated to be a homopolymer or copolymer.

In one or more embodiments, the PVC may be characterized by a number average molecular weight (Mn), which may be determined by gel permeation chromatography. In one or more embodiments, the PVC may have a Mn of greater than 20,000 g/mol, in other embodiments greater than 30,000 g/mol, in other embodiments greater than 40,000 g/mol, and in other embodiments greater than 45,000 g/mol In these or other embodiments, the PVC may have a Mn of less than 220,000g/mol, in other embodiments greater than 180,000 g/mol, in other embodiments greater than 120,000 g/mol, and in other embodiments greater than 70,000 g/mol. In one or more embodiments, the PVC may have a Mn from about 20,000 g/mol to about 220,000 g/mol, in other embodiments from about 30,000 g/mol to about 180,000 g/mol, in other embodiments from about 40,000 g/mol to about 120,000 g/mol, and in other embodiments from about 45,000 g/mol to about 70,000 g/mol.

In one or more embodiments, the PVC employed in the practice of the present invention may be characterized by a median particle size (as suspended in air or water) that is greater than 30 μm, in other embodiments greater than 50 μm, in other embodiments greater than 70 μm, in other embodiments greater than 90 μm, in other embodiments greater than 110 μm, and in other embodiments greater than 130 μm. In these or other embodiments, the PVC particles may be characterized by a suspended median particle size that is less than 900 μm, in other embodiments less than 750 μm, and in other embodiments less than 500 μm. In one or more embodiments, the PVC particles may be characterized by a suspended median particle size of from about 30 to about 900 μm, in other embodiments from about 50 to about 750 μm, in other embodiments from about 70 to about 500 μm, in other embodiments from about 90 to about 500 μm, and in other embodiments from about 110 to about 500 μm. As the skilled person appreciates, the particle size of the PVC may be determined by laser diffraction analysis of PVC suspended in water or within a gas stream using a device such as a laser light scattering particle size analyzer.

In one or more embodiments, the PVC employed in the practice of the present invention may be characterized by a porosity that is greater than 0.25 cm³/g of resin, in other embodiments greater than 0.30 cm³/g, in other embodiments greater than 0.32 cm³/g, in other embodiments greater than 0.33 cm³/g, in other embodiments greater than 0.34 cm³/g, and in other embodiments greater than 0.35 cm³/g. In these or other embodiments, the PVC particles may be characterized by a porosity that is less than 0.60 cm³/g resin, in other embodiments less than 0.50 cm³/g, and in other embodiments less than 0.40 cm³/g. In one or more embodiments, the PVC particles may be characterized by porosity from about 0.25 to about 0.6 cm³/g, in other embodiments from about 0.32 to about 0.50 cm³/g, in other embodiments from about 0.33 to about 0.40 cm³/g. As the skilled person appreciates, the porosity of the PVC may be determined by DOP plasticizer displacement (OxyVinyls Test Method 1094).

### Plasticizers

As indicated above, the PVC compositions of the present invention include a plasticizer. Suitable plasticizers include acetates, adipates, azelates, benzoates, citrates, cyclohexanoates, epoxy esters, orthophthalates, esters, phosphate esters, polymeric plasticizers, bioplasticizers, sebacates, succinates, sulfonamides, terephtalates, and trimellitates.

Examples of acetates include, but are not limited to, glyceryl triacetate.

Examples of adipates include, but are not limited to diisobutyl adipate, benzyl 2-ethylhexyl adipate, di-2-ethylhexyl adipate, diisononyl adipate, diisodecyl adipate, ditridecyl adipate, di-n-butyl adipate, di-(2-butoxyethyl) adipate, bis [2-(2-butoxyethoxy)ethyl]adipate, and di-n-octyl adipate.

Examples of azelates include, but are not limited to, diisodecyl azelate.

Examples of benzoates include, but are not limited to, neopentylglycol dibenzoate, diethylene glycol dibenzoate, dipropylene glycol dibenzoate, isononyl benzoate, isodecyl benzoate, and tri-ethylene glycol dibenzoate

Examples of citrates include, but are not limited to, triethyl citrate, tributyl citrate, acetyl tributyl citrate.

Examples of cyclohexanoates include, but are not limited to, di-isononyl cyclohexane dicarboxylate.

Examples of epoxy esters include, but are not limited to, epoxidized linseed oil and epoxidized soybean oil.

Examples of orthophthalates include, but are not limited to, dimethyl phthalate, diethyl phthalate, di-n-propyl phthalate, di-n-butyl phthalate, diisobutyl phthalate, benzyl butyl phthalate, di-n-pentyl phthalate, di-n-hexyl phthalate, diisohexyl phthalate, dicyclohexyl phthalate, diisoheptyl phthalate, di-n-octyl phthalate, diisooctyl phthalate, bis (2-ethylhexyl) phthalate, diisononyl phthalate, diisodecyl phthalate, di (2-propyl heptyl) phthalate, diisoundecyl phthalate, diisotridecyl phthalate, benzyl C7-9-branched and linear alkyl phthalate, and di-C16-18 alkyl phthalate.

Examples of esters include, but are not limited to, 2,2′-ethylenedioxydiethyl-bis-(2-ethylhexanoate), alkylsulphonic acid ester with phenol, pentaerythritol ester of valeric acid, and 2,2,4-trimethyl-1,3 pentanediol di-isobutyrate.

Examples of phosphate esters include, but are not limited to, triphenyl phosphate, 2-ethylhexyl diphenyl phosphate, and Tris (2-ethylhexyl) phosphate.

Examples of polymeric plasticizers include, but are not limited to, Hexanedioic acid, polymer with 1,2-propanediol, acetate, hexanedioic acid, polymer with 1,2-propanediol, octyl ester, and hexanedioic acid, polymer with 2,2-dimethyl-1,3-propanediol and 1,2-propanediol, isononyl ester.

Examples of sebacates include, but are not limited to, dimethyl sebacate, dibutyl sebacate, Di-2-ethylhexyl sebacate, and di-isodecyl sebacate.

Examples of succinates include, but are not limited to, dimethylsuccinate and diethylsuccinate.

Examples of sulfonamides include, but are not limited to, n-butyl benzene sulfonamide.

Examples of terephtalates include, but are not limited to, diisobutyl terephthalate, dioctyl terephthalate.

Examples of trimellitates include, but are not limited to, tris-2-ethylhexyl trimellitate.

Examples of bioplasticizers include polyhydroxyalkoanoates.

### Additives

The PVC compositions of the present invention may include additional additives based upon the desired final properties and particular use. These additives may be used to adjust or add properties to the PVC compositions. For example, it is known to include additives for mechanical properties, light and thermal stability, color, clarity and electrical properties of the product.

In one or more embodiments, the PVC compositions of the present invention may include a stabilizer. Stabilizers may provide protection from the effects of aging, dehydrodehalogenation of the polyvinyl chloride at high temperatures, and degradation due to sunlight, ozone, or biological agents. Typically, stabilizers used to provide stability during heat processing are metal compounds. Suitable metal compounds that provide heat stability include lead salts, organo-tin compounds, barium salts, cadmium salts, and calcium/zinc stabilizers. In one or more embodiments, in addition to metal compounds a co-stabilizer may be employed. Suitable co-stabilizers include organic phosphates, epoxidised esters, and polyols. Suitable stabilizers that help to reduce degradation due to sunlight, ozone and biological agents include benzotriazole and benzophenone.

In one or more embodiments, the PVC compositions of the present invention may include a filler. While fillers may be used to reduce cost, they may also have other benefits. For example, fillers may assist in dry blending, produce improved heat transmission, and provide an increase in electrical resistance, resistance to ultra-violet light, hardness, and resistance to heat deformation. Examples of suitable fillers include calcium carbonate, clays such as alumino-silicates, silica, dolomite and bauxite.

In one or more embodiments, the PVC compositions of the present invention may include a lubricant or a processing aid. Lubricants and processing aids may be included to assist in processing by reducing the adhesion between PVC and machinery surfaces. When PVC is included as a particle, lubricants may also affect the frictional properties between PVC particles during processing. Suitable lubricants include petroleum waxes, silicon oil, mineral oil, synthetic oils polyethylene waxes, stearic acid, and metal stearates. In one or more embodiments, where the PVC composition includes a metal stearate as a lubricant, the metal stearates may replace a portion or all of the stabilizer.

Other ingredients may also be included based upon based upon the desired final properties and particular use. Other ingredients that may be used in the PVC composition include flame retardants, blowing agents, antistatic agents, viscosity regulators such as thickeners and thinners, antifogging agents, bio-stabilizers, and pigments.

### Ingredient Amounts

In one or more embodiments, the PVC composition may be quantified by the percent by weight of PVC in the total weight of the PVC composition. In one or more embodiments, the PVC composition includes greater than 10% by weight, in other embodiments greater than 25% by weight, and in other embodiments greater than 35% by weight PVC based upon the total weight of the PVC composition. In these or other embodiments, the PVC composition includes less than 90% by weight, in other embodiments less than 80% by weight, and in other embodiments less than 70% by weight PVC based upon the total weight of the PVC composition. In one or more embodiments, the PVC composition includes from about 10% by weight to about 90% by weight, in other embodiments from about 25% by weight to about 80% by weight, and in other embodiments from about 10% by weight to about 70% by weight PVC based upon the total weight of the PVC composition.

In one or more embodiments, the components of the PVC composition may be described in parts by weight of the component per 100 parts by weight PVC, which the skilled person understands can be represented by the notation “phr.”

In one or more embodiments, the amount of plasticizer in the PVC composition may be greater than 25, in other embodiments greater than 50, and other embodiments greater than 75 phr (i.e. parts by weight plasticizer per 100 parts PVC). In these other embodiments, the amount of plasticizer in the PVC composition may be less than 200, in other embodiments less than 150, in other embodiments be less than 100 phr. In one or more embodiments, the amount of plasticizer with the PVC composition may be from about 25 to about 200, in other embodiments from about 50 to about 150, and other embodiments from about 75 to about 100 phr.

In one or more embodiments, the amount of stabilizer in the PVC composition may be greater than 0.5, in other embodiments greater than 1.0, and other embodiments greater than 1.5 phr. In these other embodiments, the amount of stabilizer in the PVC composition may be less than 10, in other embodiments less than 5, in other embodiments be less than 3 phr. In one or more embodiments, the amount of stabilizer within the PVC composition may be from about 0.5 to about 10, in other embodiments from about 1.0 to about 5, and other embodiments from about 0.5 to about 3 phr.

In one or more embodiments, the amount of a lubricant and/or a process aid in the PVC composition may be greater than 0.1, in other embodiments greater than 0.2, and other embodiments greater than 0.4 phr. In these other embodiments, the amount of a lubricant and/or a process aid in the PVC composition may be less than 1.0, in other embodiments less than 0.8, in other embodiments be less than 0.6 phr. In one or more embodiments, the amount of lubricant within the PVC composition may be from about 0.1 to about 1.0, in other embodiments from about 0.2 to about 0.8, and other embodiments from about 0.4 to about 0.6 phr.

In one or more embodiments, the amount of filler in the PVC composition may be greater than 10, in other embodiments greater than 30, and other embodiments greater than 50 phr. In these other embodiments, the amount of filler in the PVC composition may be less than 150, in other embodiments less than 120, in other embodiments be less than 100 phr. In one or more embodiments, the amount of filler within the PVC composition may be from about 10 to about 150 phr, in other embodiments from about 30 to about 120 phr, and other embodiments from about 50 to about 100 phr.

### Preparation of PVC Composition

In one or more embodiments, the PVC compositions of this invention may be prepared by mixing the various ingredients using conventional PVC mixing (which may also be referred to as compounding) techniques. In one or more embodiments, the PVC composition may be prepared as a dry blend, which may also be referred to as a solid blend. A dry blend is prepared by blending all of the PVC composition ingredients with a mixer (such as an intensive high-speed mixer) to blend all of the ingredients into a powder. The dry blending of the ingredients can take place, for example, at temperatures of from about 200 to about 230° F. Accordingly, embodiments of the invention include dry blends of PVC, sulfur, and optionally one or more of the ingredients disclosed herein. In one or more embodiments, the dry blends can be cooled to room temperature prior to further processing. Using conventional techniques, the dry blend compositions can then be melt processed, which typically includes heating the composition to temperatures of, for example, about 300 to about 400° F., or in other embodiments from about 320 to about 380° F., and then processing the melt by, for example, extrusion, molding, or blowing techniques.

In other embodiments, the PVC composition may be prepared as a plastisol. In these or other embodiments, PVC (along with the other ingredients of the PVC composition) is mixed with an amount of plasticizer (typically greater than 40%) that allows the PVC composition to flow like a liquid. Plastisol compositions are advantageous because they have the ability to flow like a liquid until sufficient heating causes the PVC to dissolve in the plasticizer to form a gel. Upon cooling the mixture will form a plasticized solid.

### Characteristics of PVC Compositions

In one or more embodiments, the PVC compositions of the present invention may have a non-homogenous distribution of sulfur. In certain embodiments, sulfur may concentrate near the surface of the composition.

### INDUSTRIAL APPLICABILITY

The plasticized PVC compositions may be used to prepare numerous articles, which the skilled person understands can be made by using a variety of techniques including the various plastic extrusion and molding techniques. For example, articles can be extruded, injection molded, and blow molded. The compositions can also sheeted by using various techniques such as calendering.

In one or more embodiments, articles prepared from the plasticized PVC compositions of the present invention can be used in many applications such as, but not limited to, construction, clothing, and packaging. Specific uses include pool liners and membranes.

In order to demonstrate the practice of the present invention, the following examples have been prepared and tested. The examples should not, however, be viewed as limiting the scope of the invention. The claims will serve to define the invention.

### EXAMPLES

### Samples 1-10

Flexible (i.e. plasticized) PVC compositions were prepared and tested for fungal growth according to ASTM G21. The PVC compositions were prepared using conventional PVC compounding techniques. Namely, the ingredients used to form the compositions were dry blended within a high-intensity laboratory-scale powder mixer, which was operated at about 200-230° C. The blends were cooled to room temperature, and then melt processed at 350-400° F. and extruded into sheet using a laboratory-scale Brabender extruder. The extruded sheets were fabricated into films generally having the following dimension: 2″×2″×0.017″.

The PVC was obtained under the tradename OxyVinyls 240F. The PVC compositions were prepared by mixing 53.6 phr plasticizer, 4.3 phr epoxidized soybean oil, 3.0 phr Ca/Zn stabilizer (obtained under the tradename Galata Mark 3227), 0.5 phr calcium stearate lubricant, 2.0 phr acrylic processing additive (obtained under the tradename Paraloid K120ND), and 1.0 phr TiO₂. Sulfur was added to some of the samples in the amount set forth in Table I below. Two different plasticizers were screened including dioctyl phthalate (DOP) and diisononyl phthalate (DINP). All amounts provided within the Examples section, including the amounts provided in the tables, are presented in parts by weight per 100 parts by weight PVC (“phr”) unless otherwise designated.

TABLE I

| | | | | | | | | | Colorimeter Analysis | | | |
|---|---|---|---|---|---|---|---|---|---|---|---|---|
| | | | | | | | | | | | | delta E |
| | | | G21 Rating over time (days) | | | | | Odor | L* | a* | b* | Color |
| Sample # | Plasticizer | Sulfur | 0 | 7 | 14 | 21 | 28 | Level | value | value | value | shift |
| C-1 | DINP Control #2 | 0.000 | 0 | 3 | 4 | 4 | 4 | 1 | 95.77 | −1.75 | 6.16 | Std. |
| C-2 | DINP Control #1 | 0.000 | 0 | 3 | 4 | 4 | 4 | 1 | 95.85 | −1.68 | 5.58 | Std. 3 |
| 1 | w/DINP | 0.016 | 0 | 3 | 4 | 4 | 4 | 1 | 96.06 | −1.24 | 4.34 | 0.5 |
| 2 | w/DINP | 0.032 | 0 | 3 | 4 | 4 | 4 | 1 | 96.13 | −1.24 | 4.13 | 0.7 |
| 3 | w/DINP | 0.063 | 0 | 3 | 4 | 4 | 4 | 1 | 96.13 | −1.31 | 4.44 | 0.5 |
| 4 | w/DINP | 0.125 | 0 | 2 | 3 | 3 | 4 | 1 | 96.17 | −1.34 | 4.46 | 0.5 |
| 5 | w/DINP | 0.250 | 0 | 1 | 2 | 2 | 2 | 1 | 96.05 | −1.39 | 4.60 | 0.3 |
| 6 | w/DINP | 0.500 | 0 | 0 | 1 | 1 | 2 | 1 | 95.78 | −1.50 | 5.49 | 0.7 |
| 7 | w/DINP | 1.000 | 0 | 0 | 0 | 0 | 0 | 2 | 94.03 | −1.80 | 9.62 | 3.9 |
| 8 | w/DINP | 2.000 | 0 | 0 | 0 | 0 | 0 | 3 | 92.67 | −1.85 | 11.82 | 6.5 |
| 8A | w/DINP | 5.000 | 0 | 0 | 0 | 0 | 0 | 3 | 94.05 | −2.69 | 10.53 | 4.4 |
| C-3 | DOP Control | 0.000 | 0 | 3 | 4 | 4 | 4 | 1 | 95.85 | −1.68 | 5.58 | Std. |
| 9 | w/DOP | 1.000 | 0 | 0 | 0 | 0 | 0 | 2 | 92.8 | −1.40 | 11.61 | 6.8 |
| 10 | w/DOP | 2.000 | 0 | 0 | 0 | 0 | 0 | 3 | 91.64 | −1.19 | 13.28 | 8.8 |

During the melt processing of the composition, the odor, which was believed to include sulfur-containing compounds, was noted and a qualitative ranking of the odor was attributed to the perceived odor noted. The odor ranking is set forth in Table I based upon the following odor rating system: those compositions exhibiting no odor issues were given odor level 1; those compositions exhibiting minor levels of odor were given odor level 2; and those compositions exhibiting unacceptable odor were given odor level 3.

The compositions were also analyzed for color by employing colorimeter strip testing using CIELAB Illuminant C/2° Observer Included equipment and standardized testing methods.

Each PVC film was tested for fungi growth according to ASTM G21 using a spore suspension that included Aspergillus niger (ATCC 16404), Pennicillium chrysogenum (ATCC 10106), Chaetomium globosum (ATCC 6205), Gliocladium virens (ATCC 9645), and Aureobasidium pullulans (ATCC 15233). As provided in ASTM G21, each sample was visually rated on a scale of 0 to 4, with 0 representing no fungal growth, 1 representing trace growth (less than 10%), 2 representing light growth (10-30%), 3 representing medium growth (30-60%), and 4 representing heavy growth (60-100%). The testing was performed in triplicate, and the rating provided in Table I is an average of the three tests.

As can be seen from Table I, samples that included greater than 0.063 phr sulfur started to show resistance to fungal growth with significant resistance starting to show at 0.125 phr and above. While the data provided in the table shows resistance to fungal growth above 2.0 phr sulfur, several important qualities of the PVC films began to degrade above 2.0 phr sulfur. For example, the PVC films began to have an undesirable balance of handling issues, color, and odor. As shown in Table I, the odor level started to become an issue at about 1.0 phr sulfur and was unacceptable at about 2.0 phr sulfur and higher. As also shown in Table I, yellowing, which can be observed by the human eye, began at about 1.0 phr sulfur, although it is noted that the test formulations did not include any pigment, which could extend the acceptable sulfur loadings. Sample 8A did not follow the color trend because a temperature drop of 16° F. was experienced during processing. Samples 9 and 10 show that similar resistance to fungal growth was observed with DOP in lieu of DINP, and the same issues began to be present at sulfur loadings above 2.0 phr.

### Samples 11 & 12

Flexible (i.e. plasticized) and rigid (i.e. without plasticizer) PVC compositions were prepared and tested for thermal stability according to ASTM D2538 within a Brabender Mixer operating with a #6 mixing head at 65 rpm a bowl temperature of 374° F. The ingredients included in each PVC composition are provided in Table II.

TABLE II

| | Flexible PVC | | Rigid PVC | |
|---|---|---|---|---|
| Samples | C-4 | 11 | C-5 | 12 |
| OxyVinyls 240F (Flex Grade Resin) | 100.0 | 100.0 | | |
| OxyVinyls 225P (Rigid Grade Resin) | | | 100.0 | 100.0 |
| Ca/Zn Stabilizer (Galata Mark 3227) | 3.0 | 3.0 | | |
| Tin Mercaptide Stabilizer (Mark 1900S) | | | 0.4 | 0.4 |
| Trioctyl Trimellitate (TOTM) Plasticizer | 55.0 | 55.0 | | |
| Clay Filler (Burgess No. 30) | 18.0 | 18.0 | | |
| Calcium Carbonate Filler (Omyacarb 95T) | | | 50.0 | 50.0 |
| Acrylic Processing Aid (Paraloid K120ND) | 2.0 | 2.0 | | |
| Acrylic Processing Aid (Paraloid K-175) | 1.0 | 1.0 | | |
| Calcium Stearate Lubricant | | | 1.0 | 1.0 |
| Paraffin Wax lubricant (Advawax 165) | | | 1.0 | 1.0 |
| Oxided PE Wax (Honeywell A-C629A) | | | 0.1 | 0.1 |
| Sulfur | 0.0 | 2.5 | 0.0 | 2.5 |

Brabender Thermal Stability Test, Mixing Head #6, 65 rpm @ 374° F. bowl temp.

| | | | | |
|---|---|---|---|---|
| Time to Degradation, min. | 19.1 | 21.6 | 6.7 | 4.1 |
| Stability Change, % | Std. | +13% | Std. | −39% |
| Stable Torque, mg | 782 | 829 | 2962 | 3209 |
| Temp. @ Degradation, F. | 378 | 378 | 421 | 428 |

Sample 11, when compared to C-4, shows that the addition of sulfur to a flexible, plasticized PVC composition results in an increase of the thermal stability of the PVC composition. In contradistinction, Sample 12, when compared to C-5, shows that the addition of sulfur to rigid PVC composition (i.e. without plasticizer) results in a decrease in thermal stability of the PVC composition.

### Samples 13 & 14

Rigid (i.e. without plasticizer) PVC compositions were prepared and tested for algae growth according to ASTM G29. The compositions were blended using conventional PVC mixing techniques and extruded into films generally having the following dimension: 3″×3″×0.018″. The PVC was obtained under the tradename OxyVinyls 216. The rigid PVC compositions were prepared by mixing 1.2 phr butyltin mercaptide stabilizer (Thermolite 31), 4.0 phr acrylic Impact modifier (Durastrength 200), 1.25 phr calcium stearate lubricant, 0.75 phr acrylic processing additive (obtained under the tradename Paraloid K120ND), 1.25 phr paraffin wax lubricant (advawax 165), oxided PE lubricant (Honeywell A-C629A), and 1.0 phr TiO2. Sulfur was added to some of the samples in the amount set forth in Table III below.

TABLE III

| Samples | C-6 | 13 | 14 |
|---|---|---|---|
| Sulfur | 0.0 | 0.1 | 0.5 |

Brabender Thermal Stability Test, Mixer #6, 190 C. Bowl @ 65 rpm

| | | | |
|---|---|---|---|
| Stability Time, min. | 17.7 | 16.8 | 16.5 |
| % Chg. | Std. | −5% | −7% |
| Min. Torque, mg | 2143 | 2155 | 2115 |
| Torque @ Degrade, mg | 2186 | 2312 | 2341 |
| Temp. @ Degrade, C. | 201 | 201 | 201 |
| Algae Rating @ 14 days | 3 | 4 | 4 |

As can be seen in Table III, the addition of sulfur had no impact, and potentially even a negative impact, on the algae resistance of the rigid PVC formulations. This was in stark contrast to the impact that sulfur had on plasticized PVC compositions relative to fungal growth, as shown in Table I.

Various modifications and alterations that do not depart from the scope and spirit of this invention will become apparent to those skilled in the art. This invention is not to be duly limited to the illustrative embodiments set forth herein.

1. A PVC composition comprising:
(i) polyvinyl chloride;
(ii) a plasticizer; and
(iii) sulfur;
where the PVC composition includes from about 0.05 part to 5.0 parts by weight sulfur per 100 parts by weight of the PVC in the PVC composition.

2. (canceled)

3. The PVC composition of claim 1, where the PVC composition includes from about 0.25 part to 0.75 parts by weight sulfur per 100 parts by weight of the PVC in the PVC composition.

4. The PVC composition of claim 1, where the PVC composition includes from about 0.30 part to 0.60 parts by weight sulfur per 100 parts by weight of the PVC in the PVC composition.

5. The PVC composition of claim 1, where the plasticizer is selected from acetates, adipates, azelates, benzoates, citrates, cyclohexanoates, epoxy esters, orthophthalates, esters, phosphate esters, polymeric plasticizers, sebacates, succinates, sulfonamides, terephtalates, and trimellitates.

6. The PVC composition of claim 1, where the PVC composition further includes a stabilizer.

7. The PVC composition of claim 1, where the PVC composition further includes a filler.

8. The PVC composition of claim 1, where the PVC composition further includes a lubricant, a process aid, or both a lubricant and a process aid.

9. The PVC composition of claim 1, where the PVC composition is a plastisol.

10. The PVC composition of claim 1, where the PVC composition is a dry blend.

11. The PVC composition of claim 1, where the PVC composition includes from about 10% by weight to about 99% by weight PVC based upon the total weight of the PVC composition.

12. An article prepared from a PVC composition comprising:
(i) polyvinyl chloride;
(ii) a plasticizer; and
(iii) sulfur;
where the PVC composition includes from about 0.05 part to 5.0 parts by weight sulfur per 100 parts by weight of the PVC in the PVC composition.

13. The article of claim 12, where the article has at least one surface.

14. The article of claim 12, where the distribution of sulfur is non-homogenous and is in a higher concentration at the at least one surface.

15. (canceled)

16. The article of claim 12, where the PVC composition includes from about 0.25 part to 0.75 parts by weight sulfur per 100 parts by weight of the PVC in the PVC composition.

17. The article of claim 12, where the PVC composition includes from about 0.30 part to 0.60 parts by weight sulfur per 100 parts by weight of the PVC in the PVC composition.

18. The article of claim 12, where the plasticizer is selected from acetates, adipates, azelates, benzoates, citrates, cyclohexanoates, epoxy esters, orthophthalates, esters, phosphate esters, polymeric plasticizers, sebacates, succinates, sulfonamides, terephtalates, and trimellitates.

19. The article of claim 12, where the PVC composition further includes at least one of a stabilizer, a filler, a lubricant, a process aid, or both a lubricant and a process aid.

20. (canceled)

21. (canceled)

22. The article of claim 12, where the PVC composition is a plastisol, or a dry blend.

23. (canceled)

24. The article of claim 12, where the PVC composition includes from about 10% by weight to about 99% by weight PVC based upon the total weight of the PVC composition.

25. A method for preparing a PVC composition having improved resistance to biological growth, the method comprising mixing:
(i) polyvinyl chloride;
(ii) a plasticizer; and
(iii) sulfur;
to form a PVC composition, where the PVC composition includes from about 0.05 part to 5.0 parts by weight sulfur per 100 parts by weight of the PVC in the PVC composition.

26-35. (canceled)
